(19) United States
(12) Patent Application Publication
(10) Pub. No.: US 2018/0040915 A1
(43) Pub. Date: Feb. 8, 2018

(54) SULFUR DOPED OXIDE SOLID ELECTROLYTE POWDER AND SOLID STATE BATTERY CONTAINING THE SAME

(71) Applicant: INDUSTRIAL TECHNOLOGY RESEARCH INSTITUTE, Hsinchu (TW)

(72) Inventors: Shih-Chieh LIAO, Taoyuan City (TW); Kuan-Yu KO, New Taipei City (TW); Hsiu-Fen LIN, Taichung City (TW); Jin-Ming CHEN, Taoyuan City, Taoyuan (TW)

(73) Assignee: INDUSTRIAL TECHNOLOGY RESEARCH INSTITUTE, Hsinchu (TW)

(21) Appl. No.: 15/666,126

(22) Filed: Aug. 1, 2017

(30) Foreign Application Priority Data
Aug. 2, 2016 (TW) 105124401

(51) Int. Cl. H01M 10/0562; H01M 4/40

(52) U.S. Cl. CPC H01M 10/0562; H01M 4/405; H01M 2300/0065

(57) ABSTRACT

A sulfur doped oxide solid electrolyte powder is provided. The amount of sulfur is 1 wt % to 5 wt % based on the weight of the sulfur doped oxide solid electrolyte powder. A solid state battery is also provided. The solid state battery includes a positive electrode layer, a negative electrode layer, and an electrolyte layer. The electrolyte layer includes the above sulfur doped oxide solid electrolyte powder.

### CROSS REFERENCE TO RELATED APPLICATIONS

The present application is based on, and claims priority from, Taiwan Application Number 105124401, filed on Aug. 2, 2016, the disclosure of which is hereby incorporated by reference herein in its entirety.

### TECHNICAL FIELD

The disclosure relates to a sulfur doped oxide solid electrolyte powder and a solid state battery containing the same.

### BACKGROUND

Currently, most commercial lithium batteries use organic liquid electrolytes. However, due to safety problems with this type of battery, it is imperative to develop solid electrolyte materials. After replacing traditional electrolyte solution with solid electrolytes, the structural design of batteries has become more flexible. The energy density can be efficiently improved to satisfy the demands on the energy density of the lithium batteries on the market. However, the migration rate of lithium ions in the solid electrolyte cannot be increased any further due to the limitations of the grain boundary obstruction. As a result, the lithium ion conductivity of the solid electrolyte is low and cannot meet actual demands.

Therefore, a solid electrolyte with improved lithium ion conductivity is needed for the solid electrolyte to be used in practical applications.

### SUMMARY

An embodiment of the disclosure provides a sulfur doped oxide solid electrolyte powder, wherein the amount of sulfur is 1 wt %-5 wt %, based on the weight of the oxide solid electrolyte powder.

Another embodiment of the disclosure provides a solid state battery, including a positive electrode layer, a negative electrode layer, and a solid electrolyte layer disposed between the positive electrode layer and the negative electrode layer, wherein the solid electrolyte layer includes the aforementioned sulfur doped oxide solid electrolyte powder.

A detailed description is given in the following embodiments with reference to the accompanying drawings.

### BRIEF DESCRIPTION OF DRAWINGS

The present invention can be more fully understood by reading the subsequent detailed description and examples with references made to the accompanying drawings, wherein:

FIG. 1 is a cross-sectional view of a solid state battery according to an exemplary embodiment of the present disclosure; and

FIG. 2 is a schematic view of a test unit for AC impedance analysis.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

According to an embodiment, the present disclosure provides a sulfur doped oxide solid electrolyte powder. According to some embodiments, the sulfur may be element sulfur (S) and be distributed in the grain of the oxide solid electrolyte. According to some embodiments, the oxide solid electrolyte includes lithium lanthanum titanium oxygen (LLTO). Because the radius of element sulfur and the radius of oxygen are similar, the sulfur added into the oxide solid electrolyte may partially replace oxygen to form a sulfur doped oxide solid electrolyte.

According to an embodiment, the amount of sulfur in the sulfur doped oxide solid electrolyte powder provided by the present disclosure may be 1 wt %-5 wt %, based on the weight of the oxide solid electrolyte powder. It should be noted that the sulfur doped oxide solid electrolyte powder formed with sulfur in the amount of 1 wt %-5 wt % may have good lithium ion conductivity. The results may be related to the lattice constant of the oxide solid electrolyte. When the oxide solid electrolyte is doped with an appropriate amount of sulfur, the lattice constant of the oxide solid electrolyte changes, thereby increasing the diffusion rate of lithium ions in the oxide solid electrolyte and improving the lithium ion conductivity of the oxide solid electrolyte.

Conversely, when the amount of sulfur is too low (i.e. less than 1 wt %), the amount of sulfur may be not enough to make the lattice constant of the oxide solid electrolyte change. Therefore, the migration rate of lithium ions in the grain boundary and the lithium ion conductivity cannot be increased. When the amount of sulfur is too high (i.e. over 5 wt %), other grain structures may appear, impeding the migration path of lithium ions in the grain boundary of the oxide solid electrolyte and reducing the migration rate.

According to some embodiments, a solid sintering method may be used to dope element sulfur into the oxide solid electrolyte to form the sulfur doped oxide solid electrolyte of the present disclosure. Specifically, the ingredients may be deployed according to chemical dosages and added to a designed amount of element sulfur. Depending on different oxide solid electrolytes, the selection of ingredients may be adjusted according to demand. For example, when the oxide solid electrolyte is lithium lanthanum titanium oxygen (LLTO), the ingredients may be lithium carbonate (Li₂CO₃), lanthanum hydroxide (La(OH)₃), and titanium dioxide (TiO₂). After water is added into the aforementioned ingredients, the mechanical grinding method may be used to evenly blend all of the ingredients to obtain a precursor of slurry. The mechanical grinding method may include a ball grinding method, a vibration grinding method, a turbine grinding method, a mechanical melting method, a plate-type grinding method, or another appropriate grinding method. Then, the aforementioned precursor of slurry is dried to obtain a dry precursor powder. It should be noted that if a high temperature sintering process is directly applied to the element sulfur-containing precursor powder including element sulfur at normal atmospheric pressure, SO₂ may be produced and causes a loss of sulfur. Therefore, in the embodiments of the present disclosure, a pre-sintering process is first applied to the element sulfur-containing dry precursor powder in a protective atmosphere such as hydrogen and argon mixed gas, nitrogen, or argon and at a temperature of 600° C.˜900° C. The element sulfur is doped into the grain of the oxide solid electrolyte during the pre-sintering process. Then, the solid sintering process is applied to the pre-sintered powder at normal atmospheric pressure and at a temperature of 1000° C.˜1300° C. to obtain the sulfur doped oxide solid electrolyte powder. At this time, the solid-sintered powder forms a perovskite crystal phase, whereby the sulfur doped oxide solid electrolyte powder of the present disclosure is obtained. However, depending on the demands of use, the obtained solid electrolyte powder may be ground further to the desired particle size.

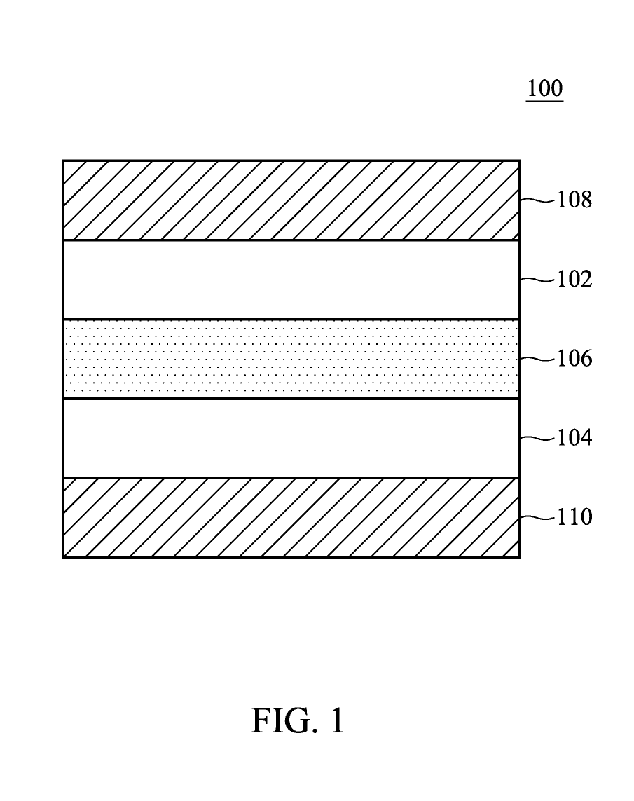

In one embodiment, the present disclosure also provides a solid state battery 100, including a positive electrode layer 102, a negative electrode layer 104, and a solid electrolyte layer 106 disposed between the positive electrode layer and the negative electrode layer, as shown in FIG. 1. In some embodiments, the positive electrode layer 102 may include well-known positive electrode active materials used in solid state batteries. For example, lithium-containing oxides. In some embodiments, the negative electrode layer 104 may include well-known negative electrode active materials used in solid state batteries. For example, carbon active materials, oxide active materials, or metal active materials such as lithium-containing metal active materials. In some embodiments, the solid electrolyte layer 106 includes the aforementioned sulfur doped oxide solid electrolyte powder, which acts as a mediate for transferring carriers (for example, lithium ions) between the positive electrode layer 102 and the negative electrode layer 104. In other embodiments, the solid electrolyte layer 106 may further include an adhesive agent, for example, polyvinylidene fluoride (PVDF), polytetrafluoroethylene (PTFE), or organic solid electrolytes such as polyoxyethylene (PEO), polyphenylene oxide (PPO), or polysiloxane. An organic/inorganic composite solid electrolyte is formed by mixing an adhesive agent or an organic solid electrolyte with the aforementioned sulfur doped oxide solid electrolyte powder. In some embodiments, at least one of the positive electrode layer 102 and the negative electrode layer 104 may include the aforementioned sulfur doped oxide solid electrolyte powder. The aforementioned organic/inorganic composite solid electrolyte may be coated on the positive electrode layer 102 or the negative electrode layer 104 to form a coating layer. Then, the negative electrode layer 104 or the positive electrode layer 104 is laminated on the coating layer, and is fixed by applying a pressure along the lamination direction.

In addition, as known to the art, the solid state batteries may further include a positive electrode current collector 108 and a negative electrode current collector 110, as shown in FIG. 1. The material, thickness, configuration, and so on of the positive electrode current collector 108 and the negative electrode current collector 110 may be selected according to the desired use. The other detailed manufacturing steps of the solid state batteries are known to the art, and hence are not described again to avoid unnecessary repetition. It should be noted that these examples are merely for explanation, and the scope of the present disclosure is not limited thereto.

The sulfur doped oxide solid electrolyte powder provided by the present disclosure can replace the isolation membrane and electrolyte solution in the most currently used lithium batteries using liquid electrolyte to be the mediate for transferring carriers between the positive electrode layer and the negative electrode layer of lithium batteries. By doping element sulfur, the present disclosure increases the transferring rate of lithium ions in the oxide solid electrolytes, improving the lithium ion conductivity thereof. Therefore, the solid electrolyte can be used practically.

The Examples and Comparative Examples are described below to illustrate the sulfur doped oxide solid electrolyte powder provided by the present disclosure and the properties thereof.

### Preparation of Oxide Solid Electrolytes

### [Example 1] Lithium Lanthanum Titanium Oxygen (LLTO)—a Sulfur Amount of 2.4 Wt %

18.2 g of lithium carbonate (Li₂CO₃; Alfa Aesar), 127.9 g of hydrogenated lanthanum (La(OH)₃; Alfa Aesar), and 105.5 g of titanium dioxide (TiO₂; Evonik Industries) were mixed with 5.2 g of element sulfur (S; Showa Chemical Industry Co., Ltd.). 500 g of water was added to the mixture and then ground for 24 hours by a ball grinding method. After all the ingredients were blended evenly, a precursor slurry was obtained. Next, the precursor slurry was oven-dried to form a dry precursor powder. The precursor powder was put into an alumina crucible and a pre-sintering process was performed under a hydrogen and argon mixed atmosphere at 800° C. for 2 hours. Finally, a solid sintering process was applied to the pre-sintered powder under normal atmospheric pressure at 1200° C. for 12 hours to obtain a powder of 213.8 g. The powder was the sulfur doped lithium lanthanum titanium oxygen (LLTO) solid electrolyte powder.

### [Comparative Example 1] Lithium Lanthanum Titanium Oxygen (LLTO)—without Sulfur Doped

The same process as described in Example 1 was repeated, expect that 18.0 g of lithium carbonate (Li₂CO₃; Alfa Aesar), 127.4 g of hydrogenated lanthanum (La(OH)₃; Alfa Aesar), and 105.1 g of titanium dioxide (TiO₂; Evonik Industries) were mixed without adding element sulfur. Finally, a powder of 212.5 g was obtained. The powder was the sulfur un-doped lithium lanthanum titanium oxygen (LLTO) solid electrolyte powder.

### Lithium Ion Conductivity Test

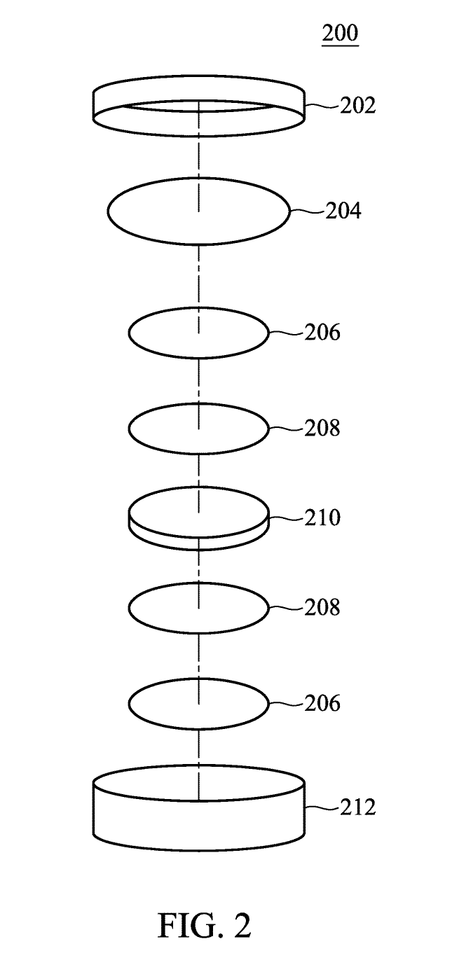

A lithium ion conductivity test was performed to the powder obtained in Example 1 and Comparative Example 1 by AC impedance analysis. The pre-sintered powder of Example 1 and Comparative Example 1 were compressed and molded into tablets. Next, the tablets were put onto an alumina crucible, and a solid sintering process was performed under normal atmospheric pressure and at 1200° C. for 12 hours to obtain tablet-shaped sulfur doped/un-doped lithium lanthanum titanium oxygen (LLTO) solid electrolyte powder. AC impedance analysis was performed using the tablet-shaped test unit 200 with the structure shown in FIG. 2. The tablet-shaped test unit 200 was composed of an upper cover 202, a lower cover 212, a pad 204, a lithium metal 206, an isolation membrane 208 (including an electrolyte solution), and a tablet-shaped doped/un-doped lithium lanthanum titanium oxygen (LLTO) solid electrolyte powder 210, as shown in FIG. 2. The results of the AC impedance analysis were calculated and the results of lithium ion conductivity of Example 1 and Comparative Example 1 are shown in Table 1.

TABLE 1

| | Grain boundary lithium ion | Total lithium ion |
|---|---|---|
| | conductivity (S/cm) | conductivity (S/cm) |
| Example 1 | 1.0 × 10⁻⁴ | 2.8 × 10⁻⁴ |
| Comparative Example 1 | 2.92 × 10⁻⁵ | 6.4 × 10⁻⁵ |

Referring to Table 1, according to experimental results, a comparison of the 2.4 wt % sulfur doped lithium lanthanum titanium oxygen (LLTO) solid electrolyte powder of Example 1 with the sulfur un-doped lithium lanthanum titanium oxygen (LLTO) solid electrolyte powder of Comparative Example 1, the grain boundary lithium ion conductivity (S/cm) increased from 2.92×10−5 (S/cm) to 1.0×10−4 (S/cm). The grain boundary lithium ion conductivity of the 2.4 wt % sulfur doped lithium lanthanum titanium oxygen (LLTO) solid electrolyte powder increased about 3˜4 times that of the original sulfur un-doped lithium lanthanum titanium oxygen (LLTO) solid electrolyte powder. In addition, the total grain lithium ion conductivity increased from 6.4×10−5 (S/cm) to 2.8×10−4 (S/cm). The total lithium ion conductivity of the 2.4 wt % sulfur doped lithium lanthanum titanium oxygen (LLTO) solid electrolyte powder increased about

4-5 times that of the original sulfur un-doped lithium lanthanum titanium oxygen (LLTO) solid electrolyte powder.

The migration rate of lithium ions in the sulfur doped oxide solid electrolyte powder provided in the present disclosure was improved, significantly increasing the total lithium ion conductivity thereof to 4-5 times that of the original sulfur un-doped oxide solid electrolyte powder. As such, the problem of the traditional solid electrolyte having poor lithium ion conductivity due to grain boundary obstruction was solved. Moreover, the sulfur doped oxide solid electrolyte powder provided in the present disclosure can be applied to solid batteries and the solid electrolyte can be used practically.

It will be apparent to those skilled in the art that various modifications and variations can be made to the disclosed embodiments. It is intended that the specification and examples be considered as exemplary only, with the true scope of the disclosure being indicated by the following claims and their equivalents.

What is claimed is:

1. A sulfur doped oxide solid electrolyte powder, wherein the amount of sulfur is 1 wt %˜5 wt %, based on the weight of the oxide solid electrolyte powder.

2. The sulfur doped oxide solid electrolyte powder as claimed in claim 1, wherein the amount of sulfur is 2 wt %˜3 wt %, based on the weight of the oxide solid electrolyte powder.

3. The sulfur doped oxide solid electrolyte powder as claimed in claim 1, wherein the sulfur is element sulfur (S).

4. The sulfur doped oxide solid electrolyte powder as claimed in claim 1, wherein the sulfur is distributed in the grain of the oxide solid electrolyte.

5. The sulfur doped oxide solid electrolyte powder as claimed in claim 1, wherein the oxide solid electrolyte comprises lithium lanthanum titanium oxygen (LLTO).

6. A solid state battery, comprising:
a positive electrode layer;
a negative electrode layer; and
a solid electrolyte layer, disposed between the positive electrode layer and the negative electrode layer, wherein the solid electrolyte layer comprises the sulfur doped oxide solid electrolyte powder as claimed in claim 1.

7. The solid state battery as claimed in claim 6, wherein the solid electrolyte layer further comprises an adhesive agent or an organic solid electrolyte.

8. The solid state battery as claimed in claim 6, wherein at least one of the positive electrode layer and the negative electrode layer comprises the sulfur doped oxide solid electrolyte powder.
